(19) United States
(12) Patent Application Publication
(10) Pub. No.: US 2017/0148048 A1
(43) Pub. Date: May 25, 2017

(54) Graphical User Interface and Object Model for Quantitative Collaborative Cognition in Open Market Systems

(71) Applicant: Commerce Signals, Inc., Davidson, NC (US)

(72) Inventors: Rodney C. Cook, Edmonds, WA (US); Thomas Noyes, Davidson, NC (US)

(73) Assignee: Commerce Signals, Inc., Davidson, NC (US)

(21) Appl. No.: 14/951,561

(22) Filed: Nov. 25, 2015

(51) Int. Cl. G06Q 30/02; G06F 3/0482; G06F 3/0484; G06F 3/0488

(52) U.S. Cl. CPC G06Q 30/0243; G06F 3/04883; G06F 3/0482; G06F 3/04842; G06Q 30/0247

(57) ABSTRACT

Methods and systems for quantitative collaborative cognition in open market systems are described herein. Aspects relating to indexing, discovery, attribution, optimization, and forecasting in open market systems are disclosed. The present invention allows for network learning, identification, and discovery of heterogeneous data held remotely by a multitude of participants in a way that protects the integrity of the data. From this data, behavior patterns of people and groups of people spanning data sets and organizational boundaries can be predicted. The data can be monetized by a variety of interested parties without disclosing the identities of parties associated with the data. The time value of data is extended under the methods and systems of the present invention.

### BACKGROUND OF THE INVENTION

1. Field of Invention

The present invention relates to methods and systems for quantitative collaborative cognition in open market systems. More preferably, the present invention provides for indexing, discovery, attribution, optimization, and forecasting in open market systems. In one embodiment, the present invention utilizes signals for quantitative collaborative cognition in open market systems. The methods and systems disclosed herein are particularly useful in commerce, and more particularly, with respect to the field of marketing and advertising.

2. Description of the Prior Art

A closed system is defined simply as a system which does not interact with other systems. On the other hand, open systems have external interactions. Most, if not all, analytic systems currently use methodology from closed systems. This presents problems with the accuracy, reliability, and usefulness of the analytics data. In particular, closed systems have historically been limited in their ability to predict behaviors through data within their own environment. The mechanics to gain incremental understanding involved either increasing the amount of direct environmental interaction (in the form of, for an example in the context of commerce, consumer visits), or acquiring the data of another entity. Acquiring the data of another entity is problematic for the entity because there is no way to limit the insights or use of the data by the recipient of the data. Similarly, there is no way to capture the incremental value provided by an external participant. Generally, it is known in the prior art to provide market data or signals as information passed between participants in a market. Examples of relevant art documents include the following:

U.S. Patent Application Publication No. 2011/0178845 for “System and Method for Matching Merchants to a Population of Consumers” by inventors Rane, et al., filed Jan. 20, 2010, describes a process of data analysis for the purpose of improving targeted advertising and analytics of data, with the major focus on drawing useful inferences for various entities from aggregated data, wherein entities are not limited to businesses and may include government agencies (census, polling data, etc.).

U.S. Patent Application Publication No. 2012/0233206 for “Methods and Systems for Electronic Data Exchange Utilizing Centralized Management Technology” by inventors Peterson, et al., filed May 24, 2012, describes an exchange of data among business entities and the process of disclosing/receiving data and a central management system for companies engaged in strategic partnership or alliance, whereas Patent 1 deals with a market place dynamic rather than a data exchange within a locked-in partnership management.

U.S. Patent Application Publication No. 2012/0066062 for “Systems and Methods to Present Triggers for Real-Time Offers” by inventors Yoder, et al., filed Aug. 8, 2011, describes collecting consumer transaction data for the benefit of targeted advertisements and an auctioning process (auction engine) for providing data clusters to clients. For example, cardholders may register in a program to receive offers, such as promotions, discounts, sweepstakes, reward points, direct mail coupons, email coupons, etc. The cardholders may register with issuers, or with the portal of the transaction handler. Based on the transaction data or transaction records and/or the registration data, the profile generator is to identify the clusters of cardholders and the values representing the affinity of the cardholders to the clusters. Various entities may place bids according to the clusters and/or the values to gain access to the cardholders, such as the user. For example, an issuer may bid on access to offers; an acquirer and/or a merchant may bid on customer segments. An auction engine receives the bids and awards segments and offers based on the received bids. Thus, customers can get great deals; and merchants can get customer traffic and thus sales.

U.S. Patent Application Publication No. 2011/0246309 for “Method, stored program, and system for improving descriptive profiles” by inventor Shkedi, filed May 25, 2011, describes a process that enables entities to acquire databanks of user profiles that can add to existing knowledge of user profile data and the process is described as a transaction in that the entities disclose a set of profile information in exchange for additional, helpful data relevant to the disclosed data.

U.S. Patent Application Publication No. 2012/0323954 for “Systems and methods for cooperative data exchange” by inventors Bonalle, et al., filed Jun. 14, 2011, describes methods that enable business entities to gain greater, useful insights on their customers and build upon their relatively limited data via consumer data exchange, wherein upon sharing/ merging/exchanging customer data, businesses can perform analysis to improve their business performance, and provides an example wherein original data may consist of a list of consumers, which can be enriched with the consumers' transaction history, search history, etc. via data exchange with other entities that own such information.

U.S. Patent Application Publication No. 2010/0262497 for “System and Methods for Controlling Bidding on Online Advertising Campaigns” by inventor Karlsson, filed Apr. 10, 2009, describes a system for managing bid prices of an online advertising campaign. The system includes a memory storing instructions for adjusting bid prices, and a campaign controller for generating a nominal bid price and a perturbation parameter, based on an ad request received from an advertiser. The system further includes an engine for generating a perturbed bid price based on the nominal bid price and the perturbation parameter, according to the instructions stored in the memory. The system further includes a serving unit for serving an ad impression based on the perturbed bid price. Also discloses that advertisers can bid on desired online ad delivery for their ad campaigns, describes management of the bidding process by managing and adjusting the bid price and describes systems and methods for a biddable multidimensional marketplace for advertising.

European Patent Application Publication No. 2063387 for “Systems and methods for a biddable multidimensional marketplace for advertising on a wireless communication device” by inventors Maggenti, et al., filed Mar. 31, 2008, describes providing targeted advertisements via mobile devices, and systems, methods and apparatus for a multidimensional bidding marketplace for providing advertising content to wireless devices. In particular, aspects allows advertising providers, to define and/or identify a one or more wireless device-based transient factors from a plurality of factors, which serve to define a targeted advertising audience and to bid on advertising based on the selected or identified transient factors.

European Patent Application No. 2076877 (also published as U.S. Patent Application Publication No. 2008/0103795) for “Lightweight and heavyweight interfaces to federated advertising marketplace” by inventors Biggs, et al., filed Oct. 18, 2007, describes a multi-party advertising exchange including advertising and publishing entities from different advertising networks, the invention provides architectures for an online advertising marketplace that range from lightweight to heavyweight implementations. A lightweight client side implementation of an interface includes centralized processing and storage of federated advertising marketplace data by centralized servers or services. A heavyweight client side implementation of an interface for advertising entities includes providing a peer instance of a federated advertising exchange application or set of processes is provided to each advertising entity as an interface for advertising entities where processing and storage are performed locally to each peer instance. Distributed advertising data can be replicated or synchronized with other peer instances.

U.S. Pat. No. 8,224,725 for “Escrowing digital property in a secure information vault” by inventors Grim, et al., filed Sep. 15, 2005, describes that data can be escrowed by receiving escrow parameters including a condition(s) for releasing the escrowed data, and an escrow recipient. An escrow contract is then created based upon the specified escrow parameters. The escrowing further includes storing the digital data in a secure information vault, and storing the escrow contract, along with a pointer to the stored data, in a database. When the condition has been satisfied, the data is released to the escrow recipient. The condition(s) for release can be a payment sum, a date, an indication from a depositor, a trustee or a vault administrator, and/or fulfillment of another escrow contract; also describes keeping data secure and releasing data to certain parties upon satisfaction of certain criteria.

U.S. Pat. No. 8,285,610 for “System and method of determining the quality of enhanced transaction data” by inventors Engle, et al., filed Mar. 26, 2009, describes “enhanced data”, non-financial data beyond the primary transaction data and includes invoice level and line item details (for examples see background section) which is collected at the merchant and delivered to a financial service network.

U.S. Patent Application Publication No. 2011/0264497 for “Systems and Methods to Transfer Tax Credits” by inventor Clyne, filed Apr. 25, 2011, includes disclosure for a list of references describing acquiring consumer purchase data.

U.S. Patent Application Publication No. 2011/0264567 for “Systems and Methods to Provide Data Services” by inventor Clyne, filed Apr. 25, 2011, describes providing access to data of diverse sources in general, and more particularly, transaction data, such as records of payment made via credit cards, debit cards, prepaid cards, etc., and/or information based on or relevant to the transaction data; also describes that transaction data can be used for various purposes and that transaction data or information derived from transaction data may be provided to third parties.

U.S. Patent Application Publication No. 2012/0066064 for “Systems and Methods to Provide Real-Time Offers via a Cooperative Database” by inventors Yoder, et al., filed Sep. 2, 2011, describes a computing apparatus is configured to: store transaction data recording transactions processed by a transaction handler; organize third party data according to community, where the third party data includes first data received from a first plurality of entities of a first community and second data received from a second plurality of entities of a second community; and responsive to a request from a merchant in the second community, present an offer of the merchant in the second community to users identified via the transaction data and the first data received from the first plurality of entities of the first community. In one embodiment, the first data provides permission from the merchant in the first community to allow the merchant in the second community to use intelligence information of the first community to identify users for targeting offers from the merchant in the second community.

U.S. Patent Application Publication No. 2012/0054189 for “User List Identification” by inventors Moonka, et al., filed Aug. 30, 2011, describes systems, methods, computer program products are provided for presenting content. An example computer implemented method includes identifying, by a data exchange engine executing on one or more processors, one or more user lists based on owned or permissioned data, each user list including a unique identifier; associating metadata with each user list including data describing a category for the user list, population data describing statistical or inferred data concerning a list or members in a given user list and subscription data including data concerning use of a given user list; storing in a searchable database a user list identifier and the associated metadata; and publishing for potential subscribers a list of the user lists including providing an interface that includes for each user list the unique identifier and the associated metadata.

U.S. Pat. No. 6,850,900 for “Full service secure commercial electronic marketplace” by inventors Hare, et al., filed Jun. 19, 2000, describes an electronic marketplace, and in particular to a full service secure commercial electronic marketplace which generically organizes, stores, updates, and distributes product information from a plurality of suppliers to facilitate multiple levels of sourcing, including contract and off-contract purchasing between the suppliers and a plurality of buyers.

The present invention relates to analytics specifically for federated data in open systems, and as such uses open systems methods, and thus provides for dramatically improved applications. U.S. application Ser. Nos. 14/214,223, 14/633,770, 14/214,253, 14/214,232, and U.S. Provisional App. No. 61/791,297, describe federated marketplaces and platforms for open systems. The federated data platform of the present invention federates data from a multiplicity of signal providers and provides signals containing these data to signal users. Thus, the present invention addresses challenges relating to data held locally in many locations (federated data). Specifically, the present invention addresses methods and systems for allowing others to discover the federated data, determining the usefulness of federated data, and allowing others to use the federated data without disclosing the underlying data.

### SUMMARY OF THE INVENTION

The present invention relates to methods and systems for quantitative collaborative cognition in open market systems. More preferably, the present invention provides for indexing, discovery, attribution, optimization, and forecasting in open market systems. In one embodiment, the present invention utilizes signals for quantitative collaborative cognition in open market systems.

One aspect of the present invention provides for a method of instantiating a multiplicity of marketing campaigns in a federated data marketplace to provide for collaborative attribution, optimization, and forecasting through a graphical user interface (GUI) in the technical field of advertising including providing at least two signals through a federated data marketplace using the GUI on a computing device connected over a communication network with a server including the federated data marketplace, estimating at least one probability density function using the at least two signals, wherein the at least one probability density function is based on a probability of at least one action of at least two users corresponding to at least two signals in response to at least one advertisement or at least one offer, wherein the at least one action includes a purchase, determining at least one probable benefit, wherein the at least one probable benefit includes a monetary benefit amount associated with the purchase, and at least one probable cost for purchasing each of the at least two signals, thereby creating a benefit/cost matrix, creating a decision array for at least one of the at least two signals, wherein the decision array includes the probability of the at least one action of at least one user corresponding to the at least one of the at least two signals in response to the at least one advertisement or the at least one offer, and creating a resultant array for the at least two signals, wherein the resultant array includes the probability of the at least one action of the at least two users corresponding to the at least two signals in response to the at least one advertisement or the at least one offer.

Another aspect of the present invention provides a method of instantiating a multiplicity of marketing campaigns in a federated data marketplace to provide for collaborative attribution, optimization, and forecasting through a graphical user interface (GUI) including transforming at least one first raw datum into at least one first signal, transforming at least one second raw datum into at least one second signal, indexing the at least one first signal and the at least one second signal in a signal database in a signal marketplace, alerting a subscriber to the signal marketplace of the availability of the at least one first signal and/or the at least one second signal in the signal database, including activating the GUI on a computing device to cause information relating to the at least one first signal and/or the at least one second signal in the signal database to display on the computing device and to enable connection via the GUI to the database over the Internet when the computing device is locally connected to a wireless network and the computing device comes online, providing the at least one first signal and the at least one second signal through the signal marketplace using the GUI on a computing device connected over a communication network with a server including the signal marketplace, estimating at least one probability density function using the at least one first signal and the at least one second signal, wherein the at least one probability density function is based on a probability of at least one action of at least two users corresponding to the at least one first signal and the at least one second signal in response to at least one stimulus, determining at least one probable benefit and at least one probable cost for purchasing the at least one first signal and/or the at least one second signal, thereby creating a benefit/cost matrix, creating a decision array for the at least one first signal and/or the at least one second signal, wherein the decision array includes the probability of the at least one action of at least one user corresponding to the at least one of the at least one first signal and/or the at least one second signal in response to the at least one stimulus; and creating a resultant array for the at least one first signal and the at least one second signal, wherein the resultant array includes the probability of the at least one action of the at least two users corresponding to the at least one first signal and the at least one second signal in response to the at least one stimulus, wherein the at least one first raw datum and the at least one second raw datum is each associated with a behavior, the behavior being related to an object, an activity, and/or an event, wherein the at least one first raw datum and the at least one second raw datum originate from different distributed data sources controlled by different owners.

Another aspect of the present invention provides a method of instantiating a multiplicity of marketing campaigns in a federated data marketplace to provide for collaborative attribution, optimization, and forecasting through a graphical user interface (GUI) including obtaining at least one first raw datum and at least one second raw datum, wherein the at least one first raw datum and the at least one second raw datum include location data obtained using a Wi-Fi router or a Wi-Fi modem, cellular triangulation or pinging, or a Global Positioning System (GPS) device, transforming the at least one first raw datum into at least one first signal, transforming the at least one second raw datum into at least one second signal, indexing the at least one first signal and the at least one second signal in a signal database in a signal marketplace, providing the at least one first signal and the at least one second signal through the signal marketplace using the GUI on a computing device connected over a communication network with a server including the signal marketplace, estimating at least one probability density function using the at least one first signal and the at least one second signal, wherein the at least one probability density function is based on a probability of at least one action of at least two users corresponding to the at least one first signal and the at least one second signal in response to at least one stimulus, determining at least one probable benefit and at least one probable cost for purchasing the at least one first signal and/or the at least one second signal, thereby creating a benefit/cost matrix, creating a decision array for the at least one first signal and/or the at least one second signal, wherein the decision array includes the probability of the at least one action of at least one user corresponding to the at least one of the at least one first signal and/or the at least one second signal in response to the at least one stimulus, and creating a resultant array for the at least one first signal and the at least one second signal, wherein the resultant array includes the probability of the at least one action of the at least two users corresponding to the at least one first signal and the at least one second signal in response to the at least one stimulus, wherein the at least one first raw datum and the at least one second raw datum is each associated with a behavior, the behavior being related to an object, an activity, and/or an event, wherein the at least one first raw datum and the at least one second raw datum originate from different distributed data sources controlled by different owners.

Advantageously, the present invention allows for network learning and identification and discovery of heterogeneous data held remotely by a multitude of participants in a way that protects the integrity of the data. The present invention is useful for establishing behavior patterns of people and groups of people spanning data sets and organizational boundaries. These behavior patterns are preferably established with respect to specific activities. By way of example, one specific activity is going out to eat. The present invention uses behavior patterns to predict a future behavior and/or to influence a behavior. Advantageously, predicting a behavior and/or successfully influencing a behavior has monetary value for a variety of participants and parties to the present invention. For example, the ability to predict and/or influence the behavior of going out to eat can hold monetary value for a number of participants including the restaurant, taxi or shuttle services, parking services, gas stations, grocery stores (providing an alternative to going out to eat), and other merchants and service providers offering goods and services incidental to the activity of going out to eat or providing an alternative to the activity of going out to eat.

One embodiment of the present invention provides for creating a form index which allows a party to identify what data is useful in predicting and/or influencing behavior. Preferably, the party is able to request access to the data that is useful in predicting and/or influencing behavior. In one embodiment, the party is able to request and receive access to the data through a platform. Exemplary federated data platforms and related aspects are described in U.S. application Ser. Nos. 14/214,223, 14/633,770, 14/214,253, 14/214,232, and U.S. Provisional App. No. 61/791,297, each of which is incorporated herein by reference in its entirety. The ability for a party to request access to data that is useful in predicting and/or influencing behavior provides for global data discovery, which is further described herein.

Although the present invention is particularly advantageous with respect to federated marketplaces, one embodiment also provides for the present invention to be utilized in a standalone model. In a standalone model, external data is preferably sourced from the environment. In a federated marketplace, the data is generally of much higher quality and therefore has greater predictive value.

In one embodiment, the present invention can be understood as addressing the question of which party will respond to a specific object or message. Preferably, the present invention provides answers to this question by first formulating a simple hypothesis as to whether an individual will respond versus the alternative that the individual will not. To minimize the risks associated with reducing this hypothesis to practice, Bayes strategies are employed. This invention allows for network learning and identification and discovery of heterogeneous data held remotely by a multitude of participants in a way that protects the integrity of the data. Establishing behavior patterns that span data sets and organizational boundaries AND the correlation of behaviors toward a given objective (such as going out to eat). Successfully predicting a behavior or successfully influencing a behavior has a monetary value. Notably, the present invention recognizes and deals with the assumptions required for implementing a Bayes strategy in opens systems. This results in innovative methods and objects together with Application Interface Touch Points and Graphical User Interface Elements.

### BRIEF DESCRIPTION OF THE DRAWINGS

FIG. 1 provides an illustration of the method by which gain and loss for the federated constituencies are accommodated by the system for a Signal Provider and a Signal User.

FIG. 2 shows the elements of the collaborative object model and the Generalized Method and Object Model for a multiplicity of Signal Providers and Users.

FIG. 3 shows a Multiplicity of Signal Providers and Signal Users, each capable of fielding numerous instances for an open data market.

FIG. 4A shows a set up process for Signal Sellers and Signal Buyers for Example 1.

FIG. 4B illustrates a Broadcast for Example 1 showing a Marketplace Process with Feedback Loop, including a test market including n of N individuals by which the fₖ(X) can be empirically obtained by federating the response obtained by the Signal Buyer from the n individuals with any numeric value in the Signal for those n individuals as supplied by the Signal Seller.

FIG. 4C illustrates a Model Fit and Forecast Process for Example 1, with the estimated mean and standard deviation calculated to fit the model for the ni Responders and the n2 Non-Responders.

FIG. 4D shows a Deployment & Attribution Process for Example 1.

FIG. 5A shows a Set Up Process for Example (Targeted Marketing), showing how a multiplicity of Signal Sellers, Signal Buyers and objects or messages can be accommodated.

FIG. 5B illustrates a Test Market Process for Example 2 (Targeted Marketing), showing how a test market including n of N individuals by which the fₖ(X) can be empirically obtained by federating the response obtained by the Signal Buyer from the n individuals with any numeric value in the Signal for those n individuals as supplied by the Signal Seller.

FIG. 5C shows a Training Process for Example 2 (Targeted Marketing).

FIG. 5D shows Deployment & Attribution for Example 2 (Targeted Marketing).

FIG. 6 shows a Graphical User Interface for a comprehensive on-going marketing campaign management application.

### DETAILED DESCRIPTION

Referring now to the drawings in general, the illustrations are for the purpose of describing a preferred embodiment of the invention and are not intended to limit the invention thereto.

The present invention relates to methods and systems for quantitative collaborative cognition in open market systems. More preferably, the present invention provides for indexing, discovery, attribution, optimization, and forecasting in open market systems. In one embodiment, the present invention utilizes signals for quantitative collaborative cognition in open market systems.

The present invention relates to the methods and systems described in U.S. application Ser. No. 14/677,315, filed Apr. 2, 2015, U.S. application Ser. No. 14/633,770, filed Feb. 27, 2015, U.S. application Ser. No. 14/214,253, filed Mar. 14, 2014, U.S. application Ser. No. 14/214,232, filed Mar. 14, 2014, U.S. application Ser. No. 14/214,233, filed Mar. 14, 2014, U.S. application Ser. No. 14/214,269, filed Mar. 14, 2014, U.S. application Ser. No. 14/214,743, filed Mar. 15, 2014, and U.S. Provisional Application No. 61/791,297, filed Mar. 15, 2013, each of which is hereby incorporated by reference in its entirety.

Preferably, the present invention utilizes Bayes strategies in providing for discovery, optimization, and forecasting in open market systems. Mathematically, one Bayes strategy can be represented by choosing d(X)=θᵣ such that hᵣ f(θᵣ) fᵣ(X)≧hₛ l(θₛ) fₛ(X) for all s≠r, where X=a vector of signals for an individual to be classified, d(X)=the decision on an X, θₖ's=the classes (offers) or categories of behaviors (responses), fₖ(X)=the value of the estimated probability density function for θₖ at point X, l(θᵣ)=the loss (or gain) associated with assigning an individual to θᵣ, and hₖ=the a priori probability of a sample belonging to category θₖ. In its most simple form, a Bayes strategy chooses, for each individual, the category of behavior for which the probability is greatest. In this most simple case, this would be responding to a single object or message (θ₁=respond; θ₂=not respond); however, the present invention can select or prioritize among multiple competing objects or messages, each with different content, for each individual within an instance. Bayes strategies that utilize probability density functions for data mining in closed systems exist in the prior art, but are narrowly focused based upon simplified assumptions. An exemplary utilization of probability density functions for data mining in closed systems is disclosed in U.S. Pat. No. 6,631,360, which is hereby incorporated by reference in its entirety. In particular, collaborative open systems are not considered in the prior art utilizing probability density functions for data mining in closed systems.

One aspect of the present invention provides for a method of instantiating a multiplicity of marketing campaigns in a federated data marketplace to provide for collaborative attribution, optimization, and forecasting through a graphical user interface (GUI) including providing at least two signals through a federated data marketplace using the GUI on a computing device connected over a communication network with a server including the federated data marketplace, estimating at least one probability density function using the at least two signals, wherein the at least one probability density function is based on a probability of at least one action of at least two users corresponding to at least two signals in response to at least one advertisement or at least one offer, wherein the at least one action includes a purchase, determining at least one probable benefit and at least one probable cost for purchasing each of the at least two signals, wherein the probable benefit includes a monetary benefit amount associated with the purchase, thereby creating a benefit/cost matrix, creating a decision array for at least one of the at least two signals, wherein the decision array includes the probability of the at least one action of at least one user corresponding to the at least one of the at least two signals in response to the at least one advertisement or the at least one offer; and creating a resultant array for the at least two signals, wherein the resultant array includes the probability of the at least one action of the at least two users corresponding to the at least two signals in response to the at least one advertisement or the at least one offer.

Another aspect of the present invention provides a method of instantiating a multiplicity of marketing campaigns in a federated data marketplace to provide for collaborative attribution, optimization, and forecasting through a graphical user interface (GUI) including transforming at least one first raw datum into at least one first signal, transforming at least one second raw datum into at least one second signal, indexing the at least one first signal and the at least one second signal in a signal database in a signal marketplace, alerting a subscriber to the signal marketplace of the availability of the at least one first signal and/or the at least one second signal in the signal database, including activating the GUI on a computing device to cause information relating to the at least one first signal and/or the at least one second signal in the signal database to display on the computing device and to enable connection via the GUI to the database over the Internet when the computing device is locally connected to a wireless network and the computing device comes online, providing the at least one first signal and the at least one second signal through the signal marketplace using the GUI on a computing device connected over a communication network with a server including the signal marketplace, estimating at least one probability density function using the at least one first signal and the at least one second signal, wherein the at least one probability density function is based on a probability of at least one action of at least two users corresponding to the at least one first signal and the at least one second signal in response to at least one stimulus, determining at least one probable benefit and at least one probable cost for purchasing the at least one first signal and/or the at least one second signal, thereby creating a benefit/cost matrix, creating a decision array for the at least one first signal and/or the at least one second signal, wherein the decision array includes the probability of the at least one action of at least one user corresponding to the at least one of the at least one first signal and/or the at least one second signal in response to the at least one stimulus; and creating a resultant array for the at least one first signal and the at least one second signal, wherein the resultant array includes the probability of the at least one action of the at least two users corresponding to the at least one first signal and the at least one second signal in response to the at least one stimulus, wherein the at least one first raw datum and the at least one second raw datum is each associated with a behavior, the behavior being related to an object, an activity, and/or an event, wherein the at least one first raw datum and the at least one second raw datum originate from different distributed data sources controlled by different owners.

Another aspect of the present invention provides a method of instantiating a multiplicity of marketing campaigns in a federated data marketplace to provide for collaborative attribution, optimization, and forecasting through a graphical user interface (GUI) including obtaining at least one first raw datum and at least one second raw datum, wherein the at least one first raw datum and the at least one second raw datum include location data obtained using a Wi-Fi router or a Wi-Fi modem, cellular triangulation or pinging, or a Global Positioning System (GPS) device, transforming the at least one first raw datum into at least one first signal, transforming the at least one second raw datum into at least one second signal, indexing the at least one first signal and the at least one second signal in a signal database in a signal marketplace, providing the at least one first signal and the at least one second signal through the signal marketplace using the GUI on a computing device connected over a communication network with a server including the signal marketplace, estimating at least one probability density function using the at least one first signal and the at least one second signal, wherein the at least one probability density function is based on a probability of at least one action of at least two users corresponding to the at least one first signal and the at least one second signal in response to at least one stimulus, determining at least one probable benefit and at least one probable cost for purchasing the at least one first signal and/or the at least one second signal, thereby creating a benefit/cost matrix, creating a decision array for the at least one first signal and/or the at least one second signal, wherein the decision array includes the probability of the at least one action of at least one user corresponding to the at least one of the at least one first signal and/or the at least one second signal in response to the at least one stimulus, and creating a resultant array for the at least one first signal and the at least one second signal, wherein the resultant array includes the probability of the at least one action of the at least two users corresponding to the at least one first signal and the at least one second signal in response to the at least one stimulus, wherein the at least one first raw datum and the at least one second raw datum is each associated with a behavior, the behavior being related to an object, an activity, and/or an event, wherein the at least one first raw datum and the at least one second raw datum originate from different distributed data sources controlled by different owners.

Advantageously, the present invention provides a method to employ probability density functions for Federated Data platforms in open markets. This method retains the full value of the estimated probability density functions which enables many capabilities unique to Federated Data platforms. By way of example and not limitation, one client of the system could deploy a marketing campaign using the Federated Data platform, thus selecting an individual to which the marketer wishes to send a product offer in a message. Similarly, another marketing campaign might wish to send an offer to that same individual; however, the individual may only be able or willing to accept one offer. A mobile device, in particular, would have a limited capacity for displaying offers in messages to a specific individual. Rather than recasting these two one category campaigns as a two category campaign to deal with a single individual, the Analytics Module can query those campaigns and chose the offer which has the highest probability of eliciting a response from the individual. In most closed systems the simplifying assumptions used in the pattern recognition method prevent the probability of response from being comparable among differing instances, such as marketing campaigns. Thus, the present invention will accommodate any analytic method in the decision rule. However, the preferred embodiment uses Probability Density Functions directly because differing models do not preclude comparisons among instances.

Because the Federated Analytics Module of the present invention will accommodate any probability density function, a wide array of applications can be supported by a scalable module. For example, Gaussian probability density functions are well recognized and attribution of the predictive contribution of each Signal is straightforward and quantitatively unbiased. Further, Gaussian estimators do not require that the data identifying individuals be retained, as only summary statistics are needed, and thus are important for applications with strict privacy requirements. Parzen density functions can be used in applications where maximum likelihood estimators are preferred. Further, arbitrary rule of logic can be used when formalized as probability density functions. Similarly, third party proprietary estimators can be accommodated. The Federated Analytics Module is thus extensible and provides for continued evolution of application programs.

A strategic consequence of open systems is that the Signals containing the predictive data and the response from the individuals are not contained within a closed system, such as a data silo or social network. Rather, potentially predictive elements of X for each individual are derived from the Signals provided by the multiplicity of Signal Providers. The response to the object or message for each individual is obtained by the Signal User. Thus most analytics simply do not have the necessary Federated Data to operate, and therefore have not been developed. The present invention defines a method by which those data structures both necessary and sufficient for analytics are constructed from the data provided by the Federated Data Platform. Thus, in the present invention, every instance is preferably a federated process enabled by the Analytics Module. The Platform accommodates from any Signal Provider the effectively infinite population of data about individuals in an open system. The Analytics Module tracks both predicted and actual responses from individuals obtained by the Signal Users. In the present invention, the Analytics Module preferably accumulates responses from individuals obtained by the Signal Users in data objects for analysis.

The mathematics for calibrating classifiers for open systems in nature is well developed in the open literature. In the Analytics Module of one embodiment of the present invention, a Signal User samples n individuals from a population of N individuals from the Signal Providers. The expected outcome for each individual (Respond and Non-Respond) is calculated from the estimated density functions, and the actual result is observed. These audit data are collated in a Decision Array for use in attribution and optimization. In a similar fashion, a sample by the Signal User of n individuals from a population of N individuals is taken and the expected response is calculated and collated in the Resultant Vector, R. For each instance or marketing campaign, the Analytics Module forms these basic data structures from certain Federated Data contained in signals and signal responses from among a wide constituency of collaborators.

With regards to loss functions, the classic loss function is a simplified model for the benefits and costs associated with correct or incorrect decisions. Generally, for closed system implementations, these Bayes strategies are narrowly focused on a static objective before they are reduced to practice; however, the simplifying assumptions regarding the loss functions are rarely if ever valid for open systems. Therefore, the present invention disregards any assumptions for closed systems and has generalized a use of the loss function as an explicit business method in its Analytics Module. The method retains a one-to-one correspondence between gains and losses for all elements of the Decision Array. The resulting Benefit/Cost Matrix, B, provides an innovative method for accommodating the full array of possible benefits and costs in an open system for Federated Data. Within an instance, these benefit and cost elements can be obtained from any arbitrary set of business or contractual arrangements among constituencies, namely the Signal Providers and Signal Users.

Significantly, a key aspect to reduce this invention to practice in a marketing embodiment is the ability to use payment, purchasing and physical presence information as inputs for the Benefit/Cost Matrix. This information allows the Federated Analytics Module to identify and report which data contribute to the shared economic value of the modeled business application. The GUI of the present invention also provides for payouts for users of the methods and systems of the present invention. The payouts are preferably in the form of monetary compensation. The GUI provides for a signal provider to receive forecast reports and attribution reports from the federated data marketplace. Preferably, the GUI is also operable to send the forecast reports and attribution reports to signal users. The forecast reports preferably contain benefits, costs, and probabilities relating to signals individually and in groups.

In one embodiment, the present invention includes computer network implementable methods and objects that are both necessary and sufficient for a comprehensive and scalable Analytics Module for Federated Data Platforms in open systems and markets.

Additionally, in one embodiment, the present invention is utilized as an improvement in the technical field of advertising. The present invention relates to methods and systems for quantitative collaborative cognition in advertising, which is an improvement in the field of advertising. More preferably, the present invention provides for indexing, discovery, attribution, optimization, and forecasting in advertising. In one embodiment, the present invention utilizes signals for quantitative collaborative cognition in advertising. Quantitative collaborative cognition has not been used in the technical field of advertising, and thus is an improvement in the technical field of advertising. Advantageously, the present invention allows for network learning and identification and discovery of heterogeneous data held remotely by a multitude of participants in a way that protects the integrity of the data. In addition, because the model is held by a neutral third party, the present invention allows for the economic value of the model to also be protected. The integrity of the data has historically not been protected in the technical field of advertising. The present invention is useful for establishing behavior patterns of people and groups of people spanning data sets and organizational boundaries. These behavior patterns are preferably established with respect to specific activities. By way of example, one specific activity is going out to eat. The present invention uses behavior patterns to predict a future behavior and/or to influence a behavior. Advantageously, predicting a behavior and/or successfully influencing a behavior has monetary value for a variety of participants and parties to the present invention, and the economic value can be measured and settled. For example, the ability to predict and/or influence the behavior of going out to eat can hold monetary value for a number of participants including the restaurant, taxi or shuttle services, parking services, gas stations, grocery stores (providing an alternative to going out to eat), and other merchants and service providers offering goods and services incidental to the activity of going out to eat or providing an alternative to the activity of going out to eat. Through advertising, these parties can use these predictions and influence the behavior of the consumer by using the data. Additionally, the present invention provides compensation for a variety of data providers in the technical field of advertising, thus making it an improvement in the technical field of advertising as the conventional field of advertising does not provide for this. Specifically, one embodiment of the present invention is directed to a method of instantiating a multiplicity of marketing campaigns in a federated data marketplace to provide for collaborative attribution, optimization, and forecasting through a graphical user interface (GUI) including providing at least two signals through a federated data marketplace using the GUI on a computing device connected over a communication network with a server including the federated data marketplace, estimating at least one probability density function using the at least two signals, wherein the at least one probability density function is based on a probability of at least one action of at least two users corresponding to at least two signals in response to at least one advertisement or at least one offer, wherein the at least one action includes a purchase, determining at least one probable benefit and at least one probable cost for purchasing each of the at least two signals, wherein the probable benefit includes a monetary benefit amount associated with the purchase, thereby creating a benefit/cost matrix, creating a decision array for at least one of the at least two signals, wherein the decision array includes the probability of the at least one action of at least one user corresponding to the at least one of the at least two signals in response to the at least one advertisement or the at least one offer; and creating a resultant array for the at least two signals, wherein the resultant array includes the probability of the at least one action of the at least two users corresponding to the at least two signals in response to the at least one advertisement or the at least one offer.

The present invention also adds specific limitations other than what is well-understood, routine, and conventional in the field of advertising. Historically, users have not been compensated for the use of their personal data, including spending data, behaviors, location data, etc. However, the present invention provides for compensation for users for use of their personal data.

In a further embodiment, the present invention includes the limitations of using a transmission server with a microprocessor and a memory to store preferences of one or more subscribers of a signal marketplace and/or a signal database, transmitting an alert from the transmission server over a data channel to a wireless device, and providing a GUI application that causes the alert to display on the subscriber computer and enables a connection from the subscriber computer to the data source over the Internet when the subscriber computer comes online. This embodiment of the present invention addresses the Internet-centric challenge of alerting a subscriber with time sensitive information when the subscriber's computer is offline. This is addressed by transmitting the alert over a wireless communication channel to activate the GUI, which causes the alert to display and enables the connection of the remote subscriber computer to the data source over the Internet when the remote subscriber computer comes online. This Internet-centric problem is solved with a solution that is necessarily rooted in computer technology.

Trackable behaviors are defined within the marketplace and may include by way of example and not limitation: purchase with one time use code, purchase with credit card, location, registration, viewing of a web site, opening of email, phone call or viewing of a television show or commercial. Marketplace rules require participants to record defined behaviors and object identifiers, which are correlated to a signal, object, event or behavior. By way of example and not limitation, an objective behavior for an automotive advertiser is consumer presence in an automotive show room. The automotive show room has a Wi-Fi hot spot which identifies devices which are present. The Wi-Fi hotspot is a signal provider. The presence signal for any given device identified by the Wi-Fi provider is of value to the campaign manager. Hence the Wi-Fi provider sells data to the automotive campaign manager.

Location data can also be obtained in a variety of other ways using non-generic computing devices besides utilizing WiFi location techniques. Examples of such non-generic computing devices include GPS devices (including GPS receivers), cellular location devices which operate through pinging or triangulation, and any other non-generic computing devices capable of determining location. Preferably, these non-generic computing devices determine location in real-time or near real-time.

Notably, one embodiment of the present invention solves the problem of prior art advertising systems and methods, namely that the value of data decays with respect to time and the prior art advertising systems present the risk that advertisers miss the opportunities to capitalize on the activities of consumers in real-time or near real-time. The pre-computer analog of the GUIs and computerized advertising of the present invention is legacy advertising systems such as word of mouth and paper, where parties would use verbal communication and physical pieces of paper to transfer information about advertising and purchasing opportunities. There is no question that computerized advertising is much different than the legacy advertising systems. The speed, quantity, and variety of advertisements and offers that can be made by advertising entities are no doubt markedly different than the advertisements that could be made in legacy advertising systems. Thus, the apparent differences between computerized advertising systems and legacy advertising systems indicate that the present invention is not merely applying ideas on computer systems, but rather is inextricably tied to computer technology. The systems and methods of the present invention cannot be performed on pen and paper, and the present invention is thus inextricably tied to computer technology. None of these limitations can be performed by a human alone.

Additionally, in one embodiment, the present invention requires specific structures, including non-generic computing devices to perform the methods of the present invention.

In one embodiment of the present invention, the invention adds a new subset of numbers, characters, or tags to the data, thus fundamentally altering the original raw datum to form signals. This is not reproducible by hand alone, but is rather inextricably tied to computer technology. The addition of the numbers, characters, or tags to the raw datum transforms the data into signals which are usable by a variety of parties, importantly protecting the raw datum and therefore increasing the value of the signals, as knowing the entirety of the raw datum dramatically decreases the value of the raw datum.

Furthermore, one embodiment of the present invention utilizes a tangible hardware interface as the GUI. Preferably, this GUI is a touchscreen.

In one embodiment of the present invention, the signals improve the functioning of the computing devices themselves, as the signals represent raw datum. The signals are smaller in size than the raw datum in one embodiment, leading to faster processing times of data which is protected and therefore advantageous over the raw datum. Thus, the present invention represents an improvement to computers in one embodiment.

In one embodiment of the present invention, the combination of method steps also produces a new and useful result in that important aspects of data of users (consumers in the advertising context) is protected and therefore retains more value over time.

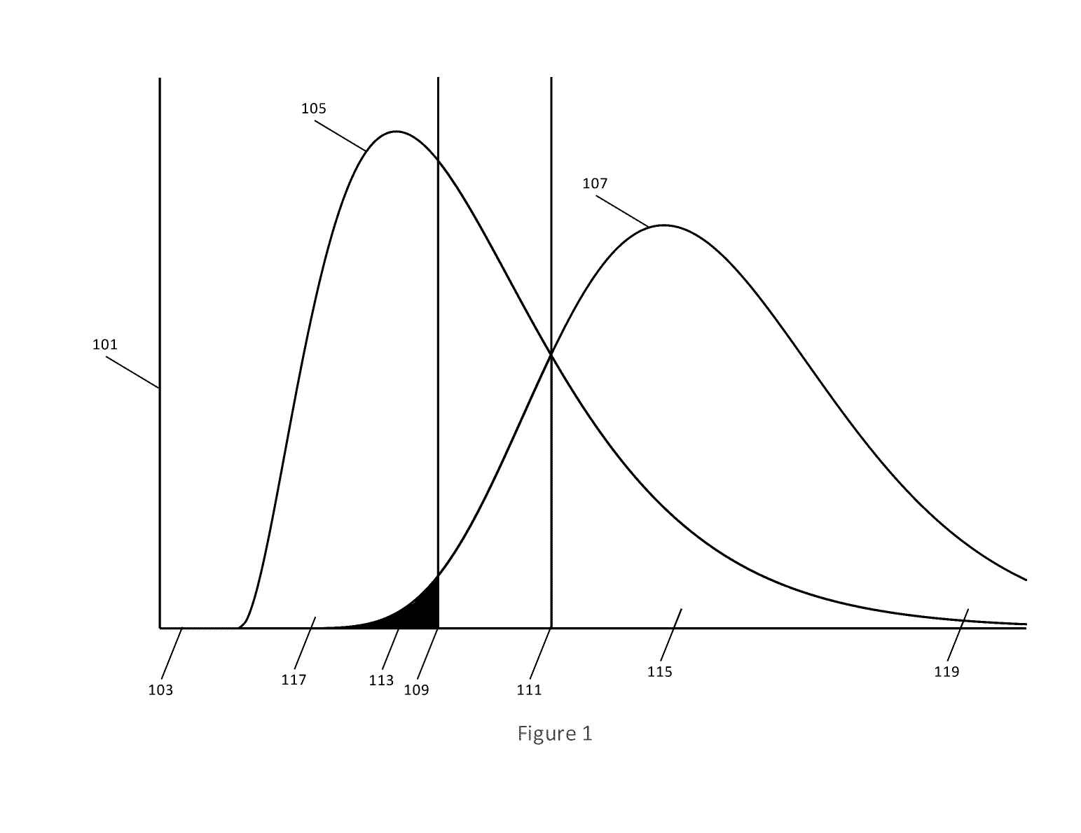

FIG. 1 provides an illustration of the method by which gain and loss for the federated constituencies are accommodated by the system for one signal provider and one signal user. The individual receiving the offer from the signal user will either respond or not respond. Therefore the categories are: θ₁=Responder and θ₂=Non Responder. The vertical axis is f(x) 101. The horizontal axis 103 is the numeric value of the signal associated with the individual to which the offer is to be delivered. In this illustration the fₖ(X) are non-Gaussian with distortions to the familiar bell shaped graph. The method will work for any valid mathematical model for fₖ(X) or derivation thereof. Shown are the estimated probability density function for the Non-Responder population 105 and the estimated probability density function for the Responder population 107. This illustrates a hypothetical difference in the value of the signal for the individuals comprising each category. In practice these probability density functions are estimated by delivering the offer to a subpopulation (test marketing), and an expectation of the performance of the method can be modeled. The decision boundary at x=b 111 is the decision boundary where the least error in classification occurs. The decision boundary at x=a 109 is the decision boundary where the estimated probable maximum gain occurs. Most useful are the classification rates for each pairwise category obtained from the empirical data. That is there is an estimate of C₁₁, the percentage of Responders that the model will correctly classify as Responders, represented by the area under the estimated probability density function curve for the Responder population from x=a to x=infinity 119; an estimate of C₂₁, the percentage of Responders that will incorrectly classify as Non-Responders, represented by the area under the estimated probability density function curve for the Responder population from x=0 to x=a 113; an estimate of C₂₂, the percentage of Non-Responders that will correctly classify as Non-Responders, represented by the area under the estimated probability density function curve for the Non-Responder population from x=0 to x=a 117; and an estimate of C₁₂, the percentage of Non-Responders that will incorrectly classify as Responders, represented by the area under the estimated probability density function curve for the Non-Responder population from x=a to x=infinity 115. The system is not limited to 2 response categories but is generalized for M categories. Preferably, a benefit and a gain is associated with each of these classification rates. Notably, FIG. 1 provides for accommodating losses and gains. In the illustration, it is assumed that the gain by correctly delivering an offer to an individual who will respond is considerably greater that the loss obtained by in correctly delivering an offer to an individual who will not respond. Thus, the decision boundary (x=a) is provided so that there is theoretically the highest probability of achieving the most gain by sending offers to individuals who fall to the right of the decision boundary. At the decision boundary, the losses and gains are offset. Mathematically, this can be represented as l(θ)₂₂C₂₂+l(θ)₂₁C₂₁=l(θ)₁₁C₁₁+l(θ)₁₂C₁₂. At x=b, the boundary for achieving the highest probability of minimum error, the gains and losses are not accommodated. Notably, the goal in drawing the decision boundary is not to minimize classification error, but rather to minimize potential losses or maximize potential gains. However, a wide variety of scenarios are possible based upon the general method and object model. For example in the case where there are a multiplicity of signal providers to an application, at the point of maximum gain there is a mathematical solution based upon to the expected percentage contribution to that gain attributed to each signal and thus for each signal provider based upon the density functions estimated from results on the sample of size n.

The Analytics Module is not limited to 2 response categories but is generalized for M categories. The Analytics Module associates a benefit and a cost with each of these classification rates. In the illustration, it is assumed that the gain by correctly delivering an object or message to an individual who will respond is considerably greater that the loss obtained by in correctly delivering an object or message to an individual who will not respond; however, a wide variety of scenarios are possible based upon the general method and object model.

### A Priori Probabilities and Prior Knowledge

This invention expands upon the simple concept of a priori probabilities to a full model of collaborative cognition for open systems. The early general case for self-organizing networks in open systems in the wild was first put forth by Hutchins (1995) in which Prior knowledge is accommodated in a variety of very powerful, unique and innovative ways. The limitations of a single scalar in traditional Bayesian strategies to characterize prior knowledge are obvious. In stand-alone applications in closed systems, they are typically sufficient; however, the Federated Data Platform is a system in which the Application Module fields numerous instances. The invention thus accommodates prior knowledge by enabling collaboration among Signal Users and Signal Providers. That is, the Federated Data Platform and Federated Analytics Module are the first and only quantitative implementation of a data driven social network for online merchants.

The Analytics Module accommodates individual expertise in a manner that is critical to instantiating and to sustaining innovation in Federated Data Ecosystem. Signal Providers have a vast reserve of expertise for which the synergies for federated signals are intuitively obvious. These Mavens can scale out beneficial instances by using the Analytics Module. Ultimately, as many instances are fielded, the Analytics Module creates a framework for collaborative discovery: a self-organizing network in which all Signal Providers and Signal Users interact with one another and adapt to one another's behaviors. A simple outcome is increased demand for signals that provide the greatest benefits, or decreased cost structure and repackaging of signal data that are less predictive. In the larger environment, a wide variety of continuously evolving user interfaces and application interfaces for a variety of Signal Providers and Users will allow these users to field increasingly effective instances by improving their respective applications. This triggers adaptive responses, both long and short term, in other campaigns as they evolve in the larger Federated Data ecosystem.

The Federated Analytics Module extends the concepts to create those certain business methods and object models that are both necessary and sufficient to enable applications in open systems.

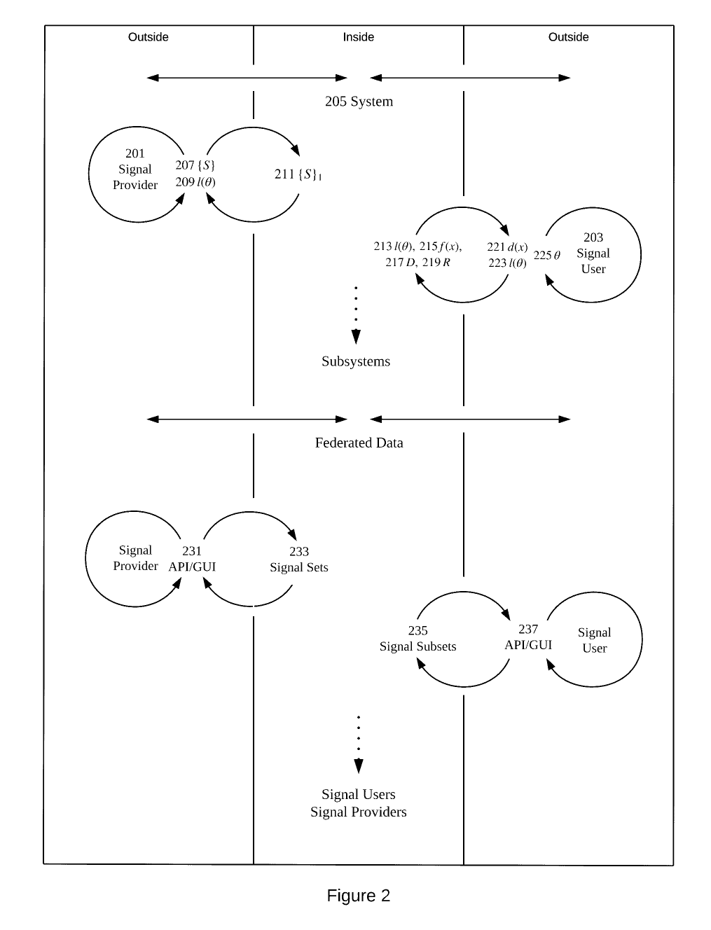

FIG. 2 shows a generalized method and object model for a multiplicity of signal providers and users. Actions occur between a signal provider 201 and a signal user 203 via a system 205. The signal provider 201 provides a set of signals 207 and an initial loss function l(θᵢ) 209. The signal user 203 configures a campaign by specifying the number of categories of offers 225. The signal user further configures the elements of a loss function l(θᵣ) 223 and then selects a subset of signals 211 from the set of signals 207 through the system 205. Preferably, the selection is made through a Graphical User Interface or an Application Interface. During the conduct of the campaign the fₖ(X) 215 are estimated and the elements of D (calibrating known results) 217 and R (testing) 219 are accumulated so that statistically valid inferences can be made during the conduct of the campaign regarding the expected future performance of the campaign so that the campaign can be improved upon. Decisions on offers 221 from the number of categories of offers 225 are provided from the system 205 to the signal user 203. Based on D 217 and R 219, an updated loss function l(θᵤ) 213 is calibrated. The system allows for a wide range of applications to operate simultaneously in various embodiments, but using a common business method. FIG. 2 also shows a signal provider 201 accessing the system 205 through an API/GUI 231. Signal sets 233 are given to the system through the API/GUI 231. Signal subsets 235 are accessible to a signal user 203 through the system 205. Preferably, the signal user 205 is able to access the system and signal subsets through a second API/GUI 237.

Sets of signals, {S}ᵢ, each comprised of Nᵢ individuals, are available from a multiplicity of Signal Sellers. These are made available by the Signal Seller to the Analytics Module through an Application Interface or Graphical User Interface. The Signal Buyer configures an instance by specifying the number of categories of objects or messages, M, the elements of the Benefit/Cost Matrix, and then selects a subset of signals to form X through a Graphical User Interface or an Application Interface. During the conduct of the instance the fₖ(X) are estimated and the elements of D and R accumulate so that statistically valid inferences regarding the expected future performance of the instance can be made during the conduct of the instance. The Analytics Module allows for a wide range of instances to operate simultaneously in various embodiments, but using common scalable methods and objects.

### Detailed Description of a Marketing Embodiment of the Invention

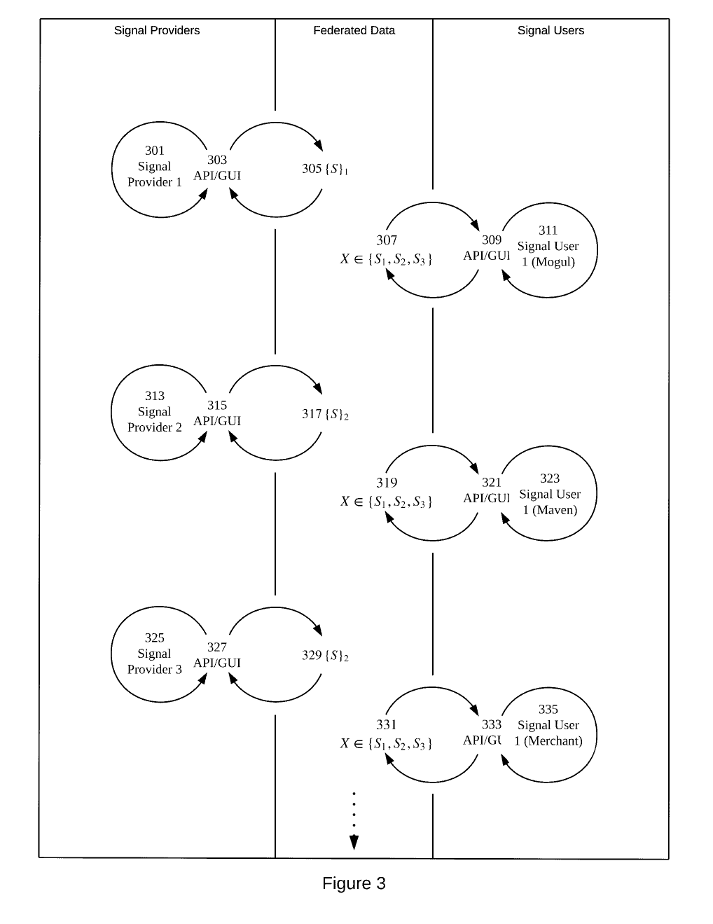

A multiplicity of applications in various embodiments each capable of fielding numerous instances for an open data market are illustrated in FIG. 3. FIG. 3 shows a multiplicity of signal providers and signal users interacting through a system. Profile data is mined in step 301. The signal provider 201 communicates via a 5^{th} API/GUI 303 with the system 205. A first set of signals 305 is identified inside the system 205. A mogul broadcasts 311 through a 1^{st} API/GUI 309. A vector of signals X provided by one of the signal providers is received 307. Purchase data is published in 313 through a 6^{th} API/GUI 315. A second set of signals 317 is identified. Another vector of signals X provided by one of the signal providers is received 319. A maven subscribes 323 via a 2^{nd} API/GUI 321. Location data is mapped 325 through a 7^{th} API/GUI 327. A third set of signals 329 is identified. Another vector of signals X provided by one of the signal providers is received 331. An ECRM or merchant 335 communicates stochastically with the system through a 3^{rd} API/GUI 333.

### EXAMPLE 1

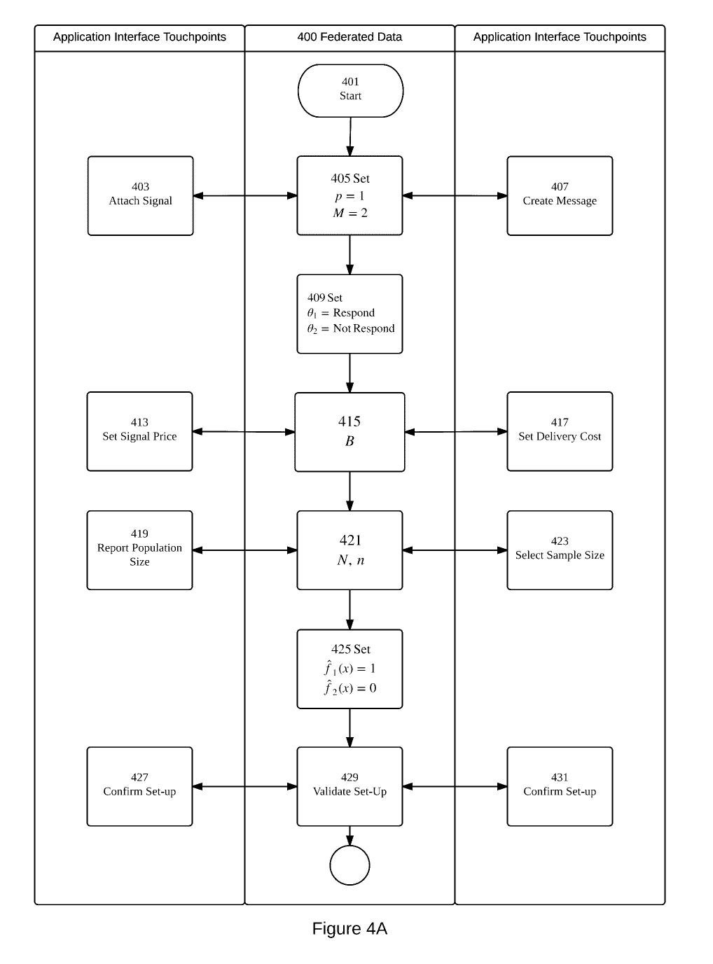

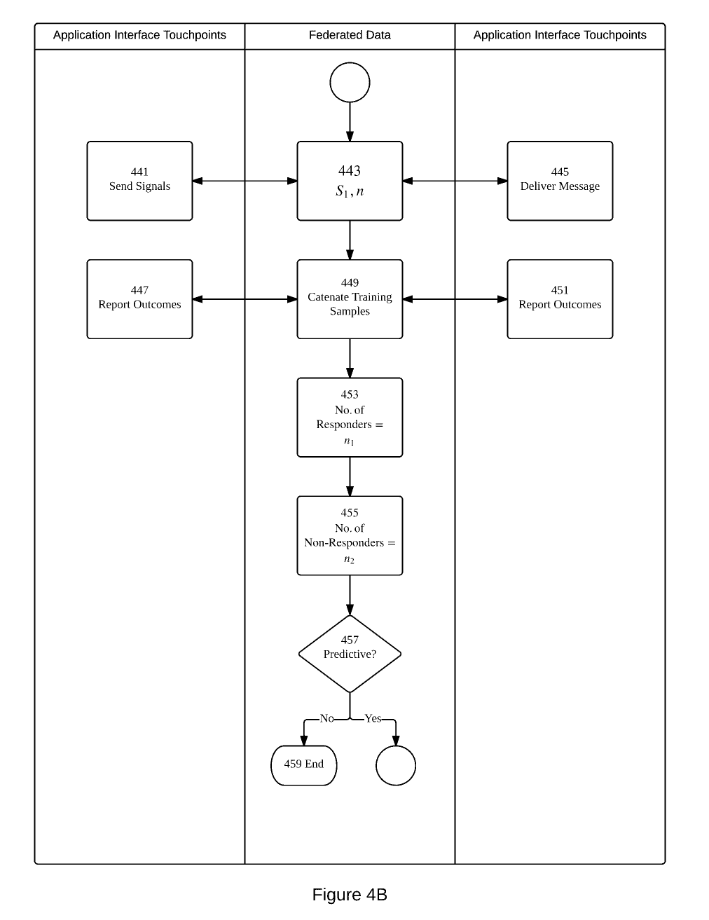

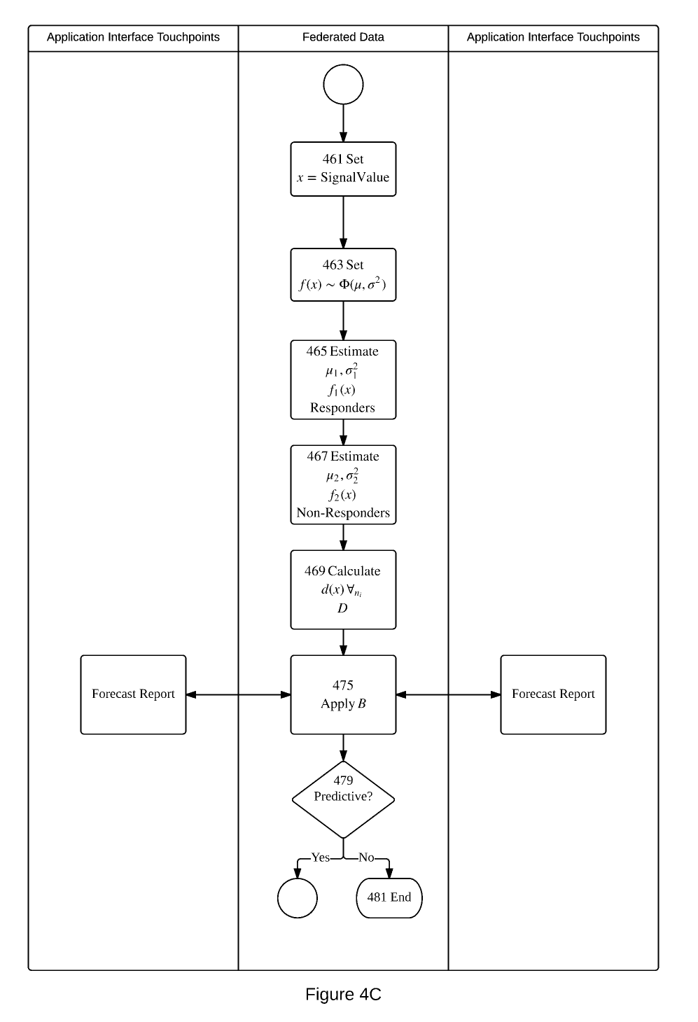

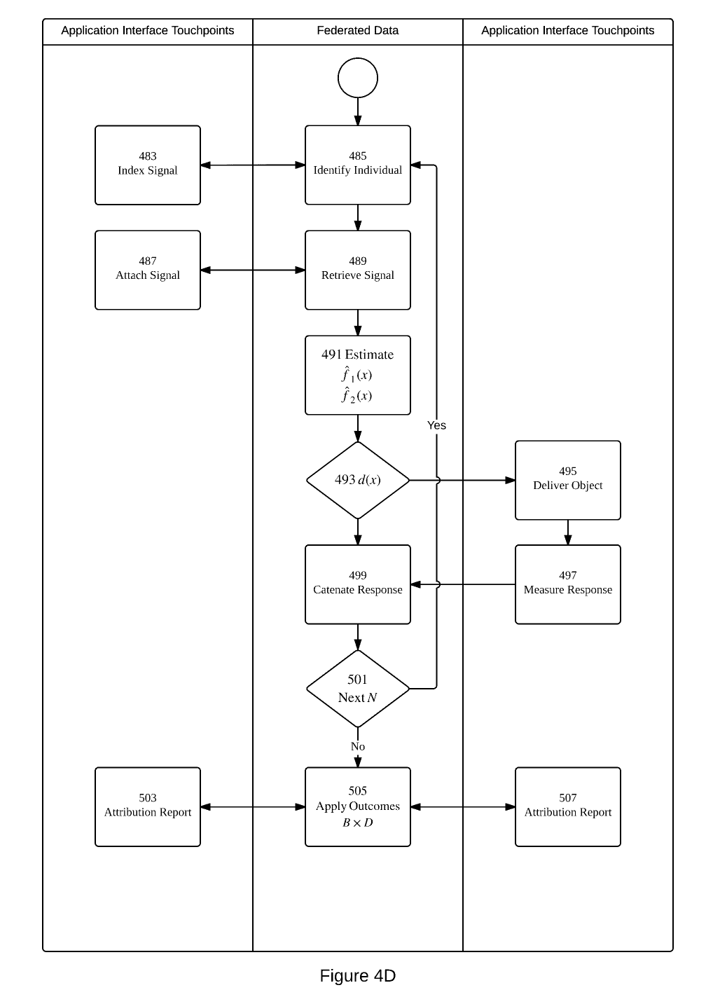

Calibrating Mavens. FIG. 4A shows a set up process for Example 1. Preferably the process steps are performed through at least one API through the platform 400. The process is started in step 401. A signal is attached in step 403. Next, p is set to be equal to 1 and M, the number of categories, is set equal to 2 in step 405. A message is created in step 407. Process step 409 includes setting θ₁=Respond and θ₂=Not Respond. Index pricing is set in step 411 and one or more signals is priced in step 413. From the signal pricing 413, a Benefit/Cost Matrix B is generated in step 415. A delivery cost is then set in step 417. The signal provider reports a population size in step 419. A sample size is selected in step 423, and a subset of n individuals from a population of N is selected in step 421. The probability density functions of responders is set equal to 1 and the population density function of nonresponders is set equal to 0 in step 425. The signal provider confirms set up in step 427. The setup is validated in step 429 at the platform. The signal user confirms the set up in step 431. In this case, a Signal Buyer and a Signal Seller have a priori agreed to a simple business exchange in which the individual managers have an intuitively obvious opportunity. These individuals are called Mavens in this example. In this simplified example only one signal is being provided and the Signal Buyer is only delivering one message. Thus p, the number of signals selected to comprise X, is set to 1, and M the number of categories is set equal to 2. θ₁ is set to be the “Responders” to the message and θ₂ is set to be the “Non-Responders” to the message. The Mavens, using their a priori competencies set mutually agreed costs and prices for the signal.

The Signal Seller then provides the total number of individuals available for message delivery and the Signal Buyer selects the number of individuals to which they wish to deliver the message. In the Analytics Module this deterministic decision to send the message to an entire list of n individuals by the Mavens is accommodated by setting the estimated distribution function value to 1 for any individual's signal value of X for each Responder, and to 0 for the Non-Responder. This will cause the Analytics Module to initially classify each individual on the list as a Responder and indicate that each individual should be contacted. Notably, the Analytics Module informs Signal Users which individuals should be contacted, but does not contact the individuals directly. In one embodiment, a Sender Module contacts the individuals directly. The net effect is that the n of N individuals comprise a test market by which the fₖ(X) can be empirically obtained by federating the response obtained by the Signal Buyer from the n individuals with any numeric value in the Signal for those n individuals as supplied by the Signal Seller. The Responders and non-Responders are segregated into separate samples and the response rate calculated. If sufficient, the system will proceed to fit a stochastic model to improve profit performance.

FIG. 4B is a continuation of the process began in FIG. 4A and shows the test market by which the fₖ(X) can be empirically obtained by federating the response obtained by the Signal Buyer from the n individuals with any numeric value in the Signal for those n individuals as supplied by the Signal Seller for Example 1. Step 441 includes sending signals between the signal provider and the platform via the API. The platform includes a subset of signals and the corresponding individuals n 443. Step 445 includes delivering a message between the platform 400 and the signal user 203.From the subset of signals and the corresponding individuals n 443, the platform catenates training samples in step 449. The outcomes of the step of catenating the training samples in step 449 are reported as outcomes in step 447 to the signal provider 201 and reported as outcomes to the signal user in step 451. In step 453, the number of responders are identified as n₁. In step 455, the number of non-responders are identified as n₂. Step 457 includes determining a signal value for each signal. If there is no signal value, the process moves to step 459 which includes ending the process. However, if there is signal value, the process continues to FIG. 4C.

For this simplified example (Example 1), a Gaussian Model fit is shown in FIG. 4. The estimated mean and standard deviation are calculated to fit the model for the ni Responders and the n₂ Non-Responders. A “hind-cast” is then performed by applying the decision rule for all of the n of N individuals. The costs and benefits are calculated for each modeled versus actual outcome, and any potential increase in profit obtained by using the Gaussian estimates of the fₖ(X) are calculated and displayed to the Signal Seller and the Signal Buyer and a decision to send the message to the remaining N individuals is made based upon the forecasted outcome revenues for the Signal Buyer and Signal Seller for those N individuals. Specifically, FIG. 4C is a continuation of the process began in FIGS. 4A and 4B and shows the model fit and forecast process for Example 1. X, a vector of signals for an individual to be classified, is set equal to a signal value in step 461. In process step 463, the functional form for the probability density function f(x) is selected to be a Gaussian Φ(μ, σ²) with a mean μ and variance σ². Process step 465 includes estimating μ₁, σ₁² for the probability density function of responders (f₁(x)). Process step 467 includes estimating μ₂, σ₂² for the probability density function of non-responders (f₂(x)). In process step 469, the decision for X is calculated for all individuals (d(x) for all nᵢ D). The Benefit/Cost Matrix B is applied in step 475. The signal provider 201 forecasts the report in step 473. The signal user 203 forecasts the report in step 477. Step 479 includes determining a profit according to how predictive the model was. If profit is not determined, the process moves to step 481 which includes ending the process. If a profit is determined, the process continues to FIG. 4D.

FIG. 4D is a continuation of the process began in FIGS. 4A, 4B, and 4C and shows the deployment and attribution process for Example 1. Process step 483 includes indexing a signal. Process step 485 includes identifying the individual associated with the signal. Process step 487 includes attaching the signal. The signal is retrieved in process step 489. Step 491 includes estimating the probability density function for responders and the probability density function for nonresponders. The step of making a decision on an X 493 is followed by delivering an object 495, measuring the response 497, and catenating the response 499. If there is another N, process steps 483, 485, 487, 489, 491, 493, 495, 497, and 499 are repeated for process step 501. If there is not another N, the outcomes are calculated in step 505 by applying the Benefit/Cost Matrix B to D which calibrates the known results. An attribution report is generated in step 503 for the signal provider 201 and in step 507 for the signal user 203.

The remaining N individuals are identified, estimates of f₁(X) and f₂(X) are calculated using Gaussian mean and variance estimates, and a decision (accommodating the agreed-to federated Benefit/Cost Matrix) is made for that individual (FIG. 1). For a yes decision the message is delivered, and the behavior of the individual as either Respond or Not Respond is noted and reported to the platform. This process is repeated for all individuals; and the outcomes are tallied; and the benefits accruing to the Signal Seller and Signal Buyer are calculated. The process is performed in real-time or in near real-time in one embodiment. The federated Benefit/Cost Matrix is updated in one embodiment of the present invention. I none embodiment, an iterative self-consistency method is used to update the federated Benefit/Cost Matrix.

### EXAMPLE 2

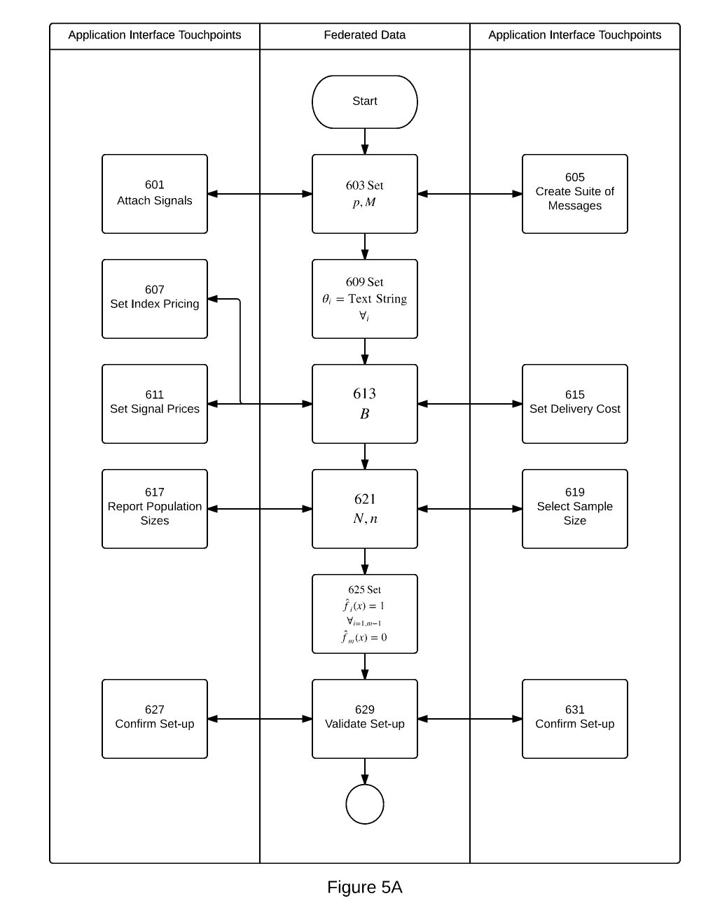

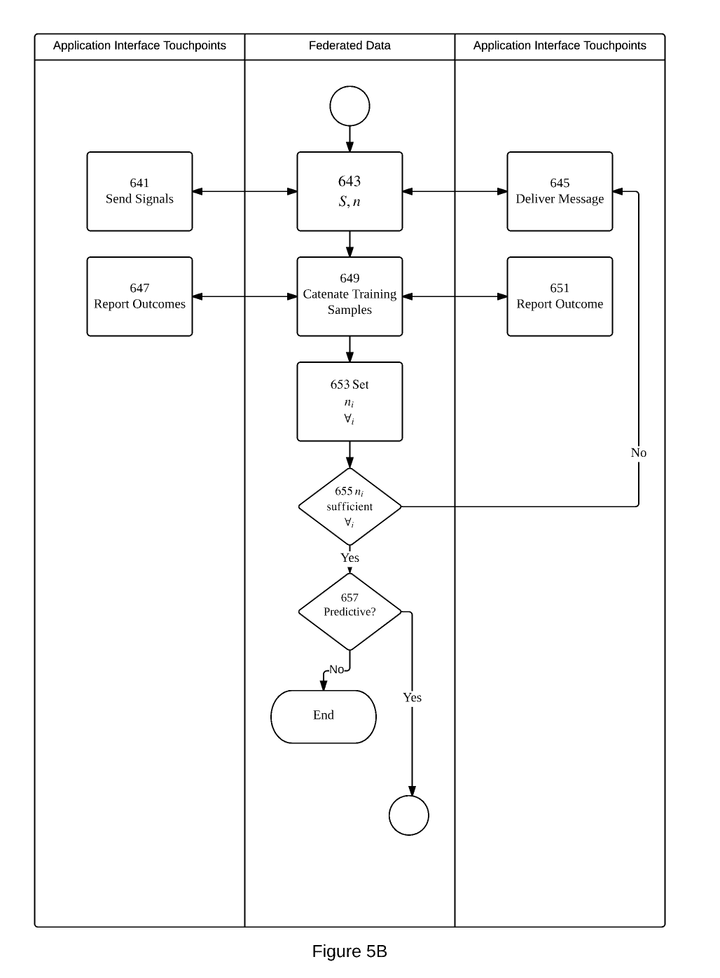

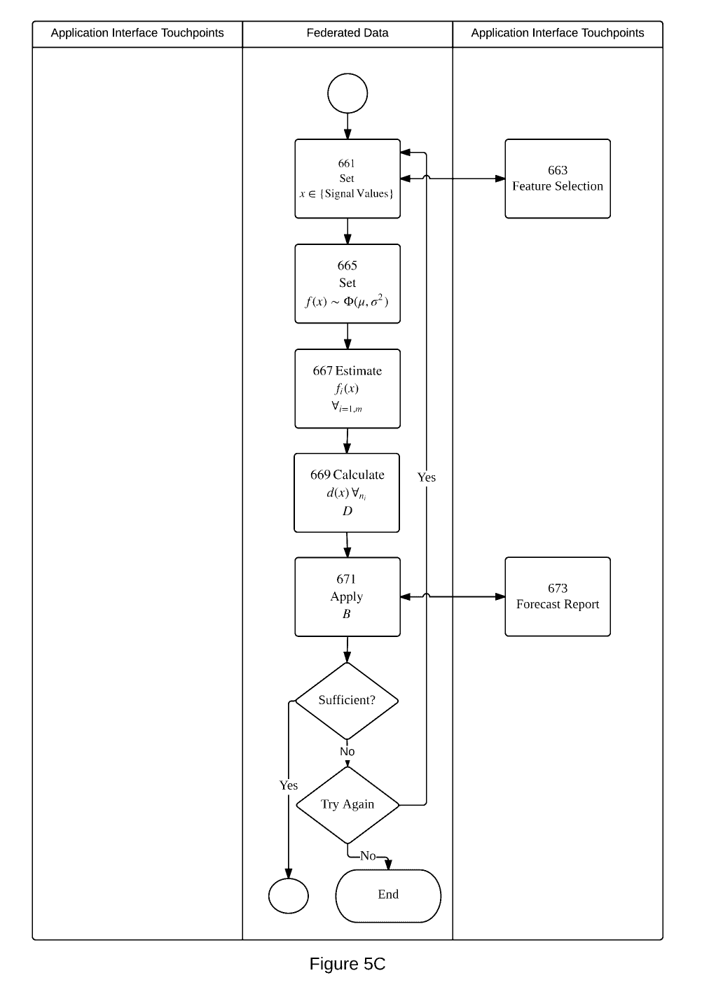

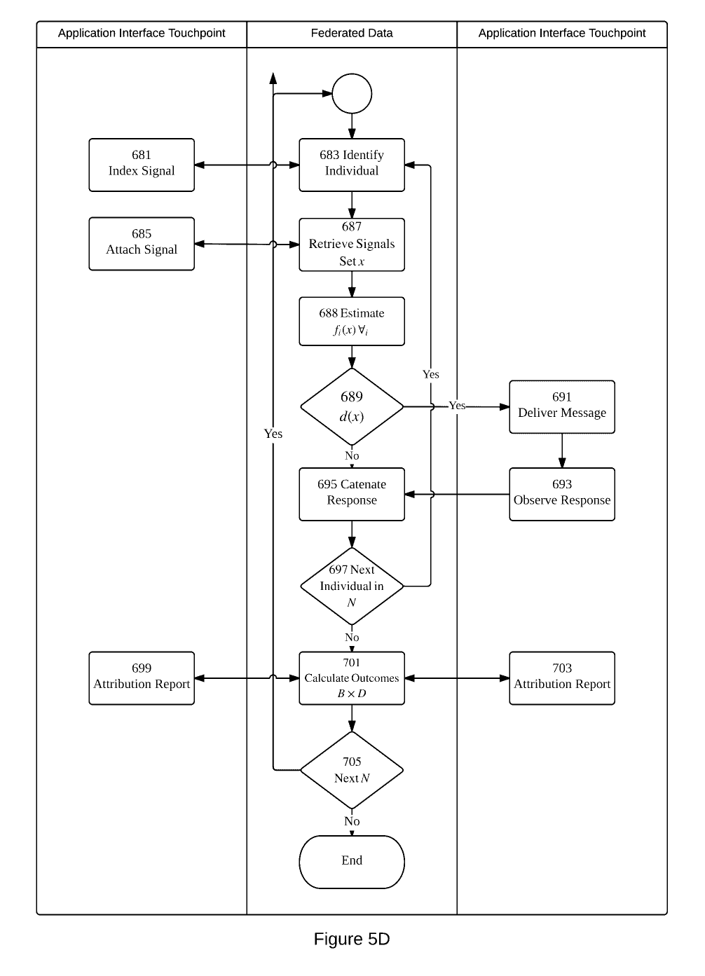

FIG. 5A shows how a multiplicity of Signal Sellers, Signal Buyers and objects or messages can be accommodated. FIG. 5A shows a set up process for Example 2 (Merchant Services). Process step 601 includes attaching signals. Process step 603 includes setting p and M. In process step 605, a suite of messages are created. Index pricing is set in process step 607. Process step 609 involves setting θ₁=Text String for all signals in the set. Signal prices are set in process step 611. A Benefit/Cost Matrix B is generated in step 613 and a delivery cost is set in step 615. The population segment size is chosen in step 617 and the sample size is chosen in step 619, and they are set to N and n, respectively, in step 621. Process step 625 includes setting fᵢ(x)=1, for all initial i=1 to m−1, and fₘ(x)=0. (This is because, in this particular example, the determination of which group to send which signal is made deterministically “by hand,” and group m is treated as non-responders.) Setup is confirmed by the signal provider in process step 627, validated in process step 629, and confirmed by the signal user in process step 631.

In this case, one of a multiplicity of Signal Buyers has a multiplicity of objects or messages that are candidates for delivery to an audience of individuals for which a multiplicity of Signal Sellers have Signals available for sale. For the sake of illustration, there is a priori information that is used by the Signal Buyer to select a set of signals. Thus p is set to the number of signals selected to comprise X, and M the number of categories is set equal to the number of messages. θᵢ is set to be the text string supplied by the Signal Buyer for each message. Signal Sellers, using their a priori competencies set costs or prices for the signals. Signal Buyers provide costs for message delivery. The data from this collaborative exchange is stored in the Benefit/Cost Matrix. The size of the population of individuals available for message delivery is reported to the Signal Seller and Signal Buyer. The Signal Buyer would then select a subset of size n to test.

In the Analytics Module this deterministic decision to send the message to an entire list of n individuals is accommodated by setting the estimated distribution function value to 1 for each Responder, and to 0 for the Non-Responder. This will cause the Analytics Module to initially classify each of the n of N individuals as a Responder and send the message to each individual.

FIG. 5B is a continuation of the process from FIG. 5A and shows a test market process for Example 2 (Merchant Services). Process step 641 includes the signal provider sending signals. Process step 643 includes defining the set of signals S and the size of the sample subset n. A message is delivered by a signal user in process step 645. Outcomes are reported by the signal providers in process step 647, and training samples are catenated in process step 649. Process step 651 involves the signal users reporting outcomes. Process step 653 involves setting nᵢ for all of i. Process step 655 includes assessing whether nᵢ is sufficient for all i. If nᵢ is insufficient, then the process returns to process step 645. If nᵢ is sufficient, then the process continues to generate a signal value in step 657. If the signal judged not to be predictive and therefore does not provide value, the process is ended. If the signal is predictive, then the process continues to FIG. 5C. As in the prior example, the net effect is that the n of N individuals comprises a test market by which the fₖ(X) can be empirically obtained by federating the response obtained by the Signal Buyer from the n individuals, together with any numeric value in the federated set of Signals for those n individuals as supplied by the Signal Seller. The individuals who respond to each message and non-Responders are segregated into separate samples and the response rates calculated. If the response rates are sufficient, the system will proceed to fit a stochastic model to improve profit performance

FIG. 5C is a continuation of the process from FIGS. 5A and 5B and shows a training process for Example 2 (Merchant Services). Process step 661 includes setting x as belonging to a set of signal values. Features are selected by the signal users in process step 663. Process step 665 includes selecting the functional form of f(x) to be the Gaussian Φ(μ, σ²). In process step 667, fᵢ(x) is estimated for all of the signals=1−m. Process step 669 includes calculating d(x) for all of ni and D. In process step 671, the Benefit/Cost Matrix B is applied. The forecast report is generated in process step 673. If the loss function generates sufficient data, then the process continues to FIG. 5D. If the loss function does not generate sufficient data, then the process begins again at process step 661 or the process is ended.

An affirmative decision effects the actions in FIG. 5D. FIG. 5D is a continuation of the process from FIGS. 5A, 5B, and 5C and shows deployment and attribution for Example 2 (Merchant Services). A signal is indexed in process step 681. An individual relating to the signal is identified in process step 683. Process step 685 includes attaching the signal. Signal set x is retrieved in process step 687. Process step 688 includes estimating fᵢ(x) for all of i. Process step 689 includes determining the categorization decision d(x). Process step 691 includes delivering a message to a signal user and process step 693 includes observing the response of the user. The response is catenated in step 695. The process moves onto the next individual in the set Nⱼ if there is another individual in process step 697, which includes beginning again at process step 681. If there are no more individuals in the set, an attribution report is generated by the signal provider in process step 699. The outcomes are calculated in process step 701 which includes multiplying the loss function times D. An attribution report is generated by the signal user in process step 703. If there is another Nⱼ, the process is repeated from the beginning of FIG. 5A via process step 705. If there is not another Nⱼ, the process is ended. Thus, the remaining N individuals are identified, estimates of the fᵢ(X) are calculated using Gaussian mean and variance estimates, and a decision as to which message has the highest probability of net benefit (accommodating the agreed-to federated loss function) is made for each individual (after FIG. 1). The message is delivered, the behavior of the individual is noted and reported to the platform. This process is repeated for all individuals, the outcomes are tallied and the benefits accruing to the Signal Seller, Signal Buyer and the Platform are calculated.

These two examples are only two of a wide array of possible applications that are enabled by the Federated Analytics Module. Example 2 illustrates that arbitrarily complex and sophisticated campaigns can be instantiated on a Federated Data Platform. Example 1 illustrates that campaigns as currently fielded in the industry can also be instantiated. The Analytics Module can operate on any campaign without modification, and can thus be scaled across the Federated Data Platform to create a collaborative cognitive ecosystem and quantitatively evolving social network of Signal Buyers and Signal Sellers. Further, the benefits and costs do not need to be prices in currency but any definition acceptable to those Signal Buyers and Sellers.

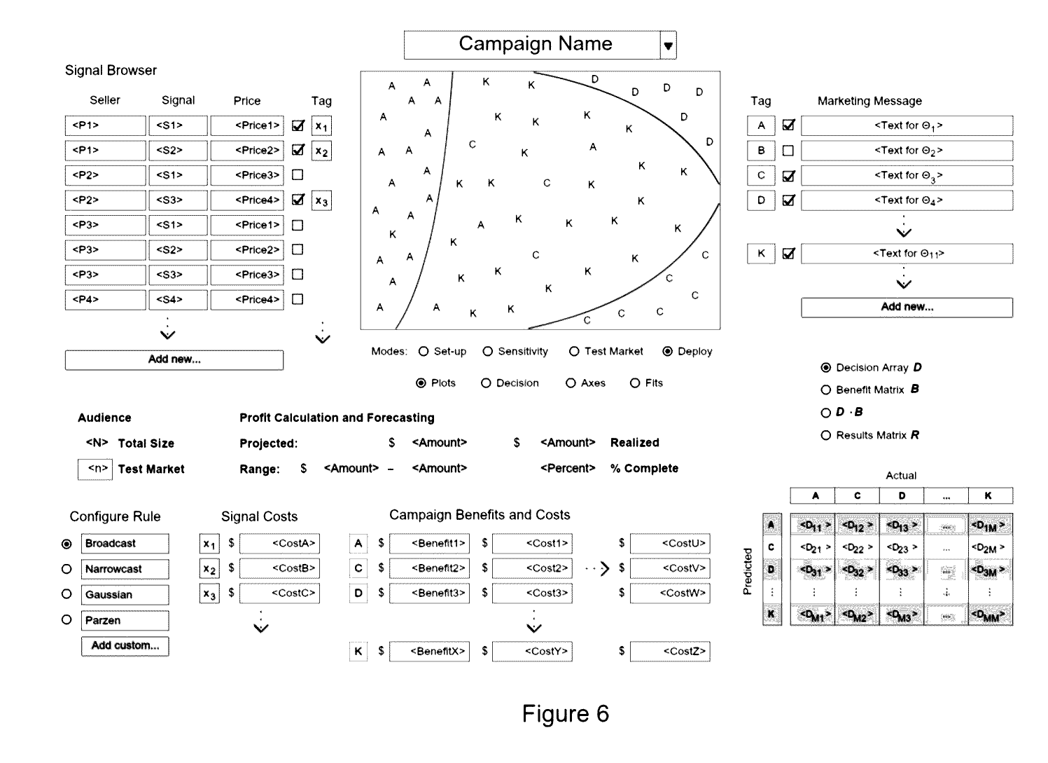

The preceding examples show how a simplified application might use the invention; however, it can be appreciated that comprehensive on-going marketing campaign management applications can use the invention. FIG. 6 shows a Graphical User Interface for such an application. In this application, a multiplicity of signals from a multiplicity of Signal Sellers and a multiplicity of marketing messages is created and delivered in a Signal Buyer's application. While the example shows a Graphical User Interface for a single Signal Buyer's application, it can be appreciated that the invention would accommodate a multiplicity of such applications for a multiplicity of Signal Buyers.

This Graphical User Interface provides an area for the Signal Buyer's application operator to enter a multiplicity of Marketing Messages for a Campaign. By engaging the “Add New . . . ” button in the Marketing Messages area, the Signal Buyer's application is invoked. The text field containing a title for each Marketing Message as well as Benefits and Costs associated with each Marketing Message contained in the Signal Buyer's application are passed to the Analytics Module and redisplayed, and control is returned to this Graphical User Interface. Within this Graphical User Interface the user can select or de-select the marketing messages, which is performed using check boxes in one embodiment of the invention. For selected messages a tag is displayed by the system.

This Graphical User Interface provides a Signal Browser area. In this area the Signals that are available for purchase and their prices from a multiplicity of Signal Sellers are listed and can be selected. As the user selects and de-selects signals, which is performed using check boxes in one embodiment of the invention, the Analytics Module displays the total number of individuals with the mix of selected signals and a recommended test market size under the Audience heading. For selected messages a tag is displayed by the system.

This Graphical User Interface provides a Configure Rule area. The user can select between various probability density functions or any derivative thereof. Preferably, this selection is performed using a plurality of radio buttons. However, other methods of selection can be used, including, inter alia, a slider and selection of a box containing text describing a probability density function. The invention is extensible and can accommodate methods provided by the user, through the Add Custom selection.

This Graphical User Interface provides a Profit Calculation and Forecasting area. In this area the costs for the selected signals are displayed. The benefits and costs specified for each marketing message (supplied by the Signal Buyer's application) are also re-displayed. Also displayed is an array for the values of the Benefit Matrix, the Decision Array, and the product thereof. The tags for the selected marketing messages are displayed as row and columns headings. The actual profit from test marketing is displayed and the projected profit for the entire audience is displayed.

This Graphical User Interface provides four modes: Set-up, Sensitivity, Test Market, and Deploy. In the Set-up mode the User interactively selects signals and marketing messages and a test market size. The costs for test marketing are interactively consolidated and those values displayed in a Benefit/Cost Matrix B. A break-even targeting accuracy, based upon benefits, and other performance calculations can also displayed. In Sensitivity Mode the User interactively edits cost elements and the consolidated elements are re-calculated and re-displayed. In Test Market Mode n signals are transferred from the Signal Seller to the Signal Buyer the messages delivered by the Signal Buyer's application and the results reported to the Analytics Module and the values displayed in a Decision Array D. In Deploy Mode the N signals are transferred from the Signal Seller to the Signal Buyer the messages delivered by the Signal Buyer's application and the results reported to the Analytics Module and the values displayed in a Results Matrix R.

The Graphical User Interface provides a central three dimensional interactive fly through in a central data view area. In Set Up mode the data view shows the univariate frequency histogram of the currently highlighted signal, plus any peripheral data that the Signal Seller may wish to provide and the Signal Buyer is permissioned to receive via the Federated Data Platform. In Sensitivity mode the full set of frequency histograms for the selected set of signals is displayed. In Test Market mode, the p-tuple of signal values for each individual consumer provided by the Signal Seller is plotted. In this example the axes are the first three signal values, tagged as xi, x2 and x3 in the figure. The estimated probability density function can be shown for the targeted audience for each marketing message. If a test market has been conducted, the user can select Sensitivity mode and control points are added to the decision surfaces to enable the user to shift those decision surfaces and interactively examine the effects on profitability. Should a lower signal price be appropriate for profitability, a bid to the Signal Seller could be made via the Federated Data Platform. In Sensitivity Mode, the estimated probability density functions can be displayed. Alternate probability density functions can be selected to examine effects on accuracy and profitability. In Deploy mode, the decision surfaces separating the market segments are displayed and the p-tuple for the each individual consumer is plotted.

From this example it can be appreciated that the current invention can field an arbitrarily complex marketing campaign. This Graphical User Interface visually and mathematically integrates the complexities of selecting among a multiplicity of marketing messages, of selecting among a multiplicity of signal values from among a multiplicity of signal sellers, conducting a sensitivity analysis of benefits and costs for these selections, analyzing the response from a portion of the audience from test marketing, projecting the profit, and analyzing the deployment of the campaign to a larger audience. It can also be appreciated that additional intuitively obvious complexities in the Graphical User Interface can be accommodated by the invention. By way of example and not limitation the Audience could be segmented for a step wise deployment; the cost structure associated with a campaign could include any conceivable option; and the Profit and Forecasting section could accommodate any of a wide array of mathematical techniques in common use. This invention is focused on those objects and methods that comprise the federated analytic process for an open federated data platform, thus enabling application capabilities previously unavailable. It can be further appreciated that very simple campaigns, such as that discussed in Example 1, can be easily scripted and fielded by using the Graphical User Interface touchpoints for this invention. A multiplicity of applications programs each hosting a multiplicity of campaigns can be hosted in a scalable and repeatable fashion by the Analytics Module. As such, the Graphical User Interface for this invention makes it intuitively obvious for Signal Sellers and Signal Buyers to integrate Federated Data and Federated Analytics into full suites of new and existing application programs.

Additional steps in the systems and methods of the present invention include retaining control of signal data within a defined use of the signal by a registered buyer, based upon at least one rule and/or the signal owner limiting signal availability to signal buyers within the federated data marketplace based upon at least one rule, wherein the at least one rule includes factors regarding: buyer identity, campaign type, signal requested, price, redemption signal type, purchase quantity, past performance of signal, past performance of campaign type, past performance of buyer, and combinations thereof. In one embodiment, the platform or system is operable to determine which offer has the highest probability of eliciting a response from the individual. Preferably, the system or platform determines the offer having the highest probability of eliciting a response by considering the past responses of the individual to identical or similar offers. In another embodiment, the system or platform determines the offer having the highest probability of eliciting a response by considering the past responses of individuals with at least one of similar interests, geographies, income, status, age, gender, occupation, family size, religious background, political affiliation, physical features, possessions, habits, services subscribed to, items purchased, housing situations, and combinations thereof

While these examples illustrate and describe an embodiment of the invention for open markets, it will be appreciated that within the scope of the claims various changes can be made to accommodate a wide array of information and mediums of exchange within with departing from the spirit of the invention.

The invention claimed is:

1. A method of instantiating a multiplicity of marketing campaigns in a federated data marketplace to provide for collaborative attribution, optimization, and forecasting through a graphical user interface (GUI) in the technical field of advertising comprising: providing at least two signals through a federated data marketplace using the GUI on a computing device connected over a communication network with a server including the federated data marketplace;
estimating at least one probability density function using the at least two signals, wherein the at least one probability density function is based on a probability of at least one action of at least two users corresponding to at least two signals in response to at least one advertisement or at least one offer, wherein the at least one action includes a purchase;
determining at least one probable benefit, wherein the at least one probable benefit includes a monetary benefit amount associated with the purchase, and at least one probable cost for purchasing each of the at least two signals, thereby creating a Benefit/Cost Matrix;
creating a decision array for at least one of the at least two signals, wherein the decision array includes the probability of the at least one action of at least one user corresponding to the at least one of the at least two signals in response to the at least one advertisement or the at least one offer; and
creating a resultant array for the at least two signals, wherein the resultant array includes the probability of the at least one action of the at least two users corresponding to the at least two signals in response to the at least one advertisement or the at least one offer.

2. The method of claim 1 wherein the GUI includes touch points, wherein the touch points are operable to allow at least one signal provider through the computing device connected over the communication network with the server including the federated data marketplace to publish signals for selection, publish prices of signals, receive the probability of the at least one action of at least one user corresponding to the at least one of the at least two signals in response to the at least one stimulus from a signal user for the decision array using a second computing device connected over the communication network with the server including the federated data marketplace, receive the at least one probable benefit and at least one probable cost for the signal user purchasing each of the at least two signals, receive forecast reports, send the forecast reports to the signal user, receive attribution reports, and send the attribution reports to the signal user.

3. The method of claim 1 wherein the GUI includes touch points, wherein the touch points are operable to allow at least one signal buyer through the computing device connected over the communication network with the server including the federated data marketplace to: set the number of messages in a campaign, select desired signals from a multiplicity of signal providers via a multiplicity of computing devices connected over the communication network with the server including the federated data marketplace, enter campaign costs into the Benefit/Cost matrix, receive the at least one probable benefit and at least one probable cost for the signal user for purchasing each of the at least two signals, receive forecast reports, and receive attribution reports.

4. The method of claim 1, wherein the at least one probable benefit and/or at least one probable cost is based on purchasing information of the at least two users or location information of the at least two users.

5. The method of claim 1, further comprising indexing the Benefit/Cost matrix, the decision array, and the resultant array in the federated data marketplace.

6. The method of claim 1, wherein raw data underlying the at least two signals is not indexed in the federated data marketplace.

7. The method of claim 1, further comprising adjusting the probability density function based on the at least one action of at least one of the at least two users corresponding to the at least two signals in response to the at least one stimulus.

8. The method of claim 1, further comprising discovering signals through the GUI using search criteria, wherein the search criteria includes a location, a time, a market, a benefit range, and/or a cost range.

9. The method of claim 1, further comprising estimating the value of the at least two signals toward a given objective to determine a price and/or a probable performance.

10. The method of claim 1, further comprising testing the usefulness of data within a decision array.

11. The method of claim 1, further comprising using an object state estimator to estimate a location of at least one of the at least two users, wherein the at least one probability density function is also on the location of the at least one of the at least two users.

12. The method of claim 1, wherein the GUI provides a central three dimensional interactive fly through in a central data view area.

13. The method of claim 1, wherein the step of providing the at least two signals through the federated data marketplace using the GUI on the computing device connected over the communication network with the server including the federated data marketplace includes combining at least one other signal through the federated data marketplace using a second GUI on a second computing device connected over the communication network with the server including the federated data marketplace combines the computing device and the second computing device into a single signal account using computer associated nodes.

14. The method of claim 1, further comprising the step of creating the at least two signals from raw datum in real-time, wherein the step of providing the at least two signals through the federated data marketplace using the GUI on the computing device connected over the communication network with the server including the federated data marketplace is performed in real-time.

15. A method of instantiating a multiplicity of marketing campaigns in a federated data marketplace to provide for collaborative attribution, optimization, and forecasting through a graphical user interface (GUI) comprising:
transforming at least one first raw datum into at least one first signal;
transforming at least one second raw datum into at least one second signal;
indexing the at least one first signal and the at least one second signal in a signal database in a signal marketplace;
alerting a subscriber to the signal marketplace of the availability of the at least one first signal and/or the at least one second signal in the signal database, including activating the GUI on a computing device to cause information relating to the at least one first signal and/or the at least one second signal in the signal database to display on the computing device and to enable connection via the GUI to the database over the Internet when the computing device is locally connected to a wireless network and the computing device comes online;
providing the at least one first signal and the at least one second signal through the signal marketplace using the GUI on a computing device connected over a communication network with a server including the signal marketplace;
estimating at least one probability density function using the at least one first signal and the at least one second signal, wherein the at least one probability density function is based on a probability of at least one action of at least two users corresponding to the at least one first signal and the at least one second signal in response to at least one stimulus;
determining at least one probable benefit and at least one probable cost for purchasing the at least one first signal and/or the at least one second signal, thereby creating a benefit/cost matrix;
creating a decision array for the at least one first signal and/or the at least one second signal, wherein the decision array includes the probability of the at least one action of at least one user corresponding to the at least one of the at least one first signal and/or the at least one second signal in response to the at least one stimulus; and
creating a resultant array for the at least one first signal and the at least one second signal, wherein the resultant array includes the probability of the at least one action of the at least two users corresponding to the at least one first signal and the at least one second signal in response to the at least one stimulus,
wherein the at least one first raw datum and the at least one second raw datum is each associated with a behavior, the behavior being related to an object, an activity, and/or an event;
wherein the at least one first raw datum and the at least one second raw datum originate from different distributed data sources controlled by different owners.

16. The method of claim 15, further comprising obtaining the at least one first raw datum and the at least one second raw datum in real-time.

17. The method of claim 16, wherein the steps of transforming the at least one first raw datum into the at least one first signal, transforming the at least one second raw datum into the at least one second signal, indexing the at least one first signal and the at least one second signal in the signal database in the signal marketplace are performed in real-time.

18. A method of instantiating a multiplicity of marketing campaigns in a federated data marketplace to provide for collaborative attribution, optimization, and forecasting through a graphical user interface (GUI) comprising:
obtaining at least one first raw datum and at least one second raw datum, wherein the at least one first raw datum and the at least one second raw datum include location data obtained using a Wi-Fi router or a Wi-Fi modem, cellular triangulation or pinging, or a Global Positioning System (GPS) device;
transforming the at least one first raw datum into at least one first signal;
transforming the at least one second raw datum into at least one second signal;
indexing the at least one first signal and the at least one second signal in a signal database in a signal marketplace;
providing the at least one first signal and the at least one second signal through the signal marketplace using the GUI on a computing device connected over a communication network with a server including the signal marketplace;
estimating at least one probability density function using the at least one first signal and the at least one second signal, wherein the at least one probability density function is based on a probability of at least one action of at least two users corresponding to the at least one first signal and the at least one second signal in response to at least one stimulus;
determining at least one probable benefit and at least one probable cost for purchasing the at least one first signal and/or the at least one second signal, thereby creating a benefit/cost matrix;
creating a decision array for the at least one first signal and/or the at least one second signal, wherein the decision array includes the probability of the at least one action of at least one user corresponding to the at least one of the at least one first signal and/or the at least one second signal in response to the at least one stimulus; and
creating a resultant array for the at least one first signal and the at least one second signal, wherein the resultant array includes the probability of the at least one action of the at least two users corresponding to the at least one first signal and the at least one second signal in response to the at least one stimulus, wherein the at least one first raw datum and the at least one second raw datum is each associated with a behavior, the behavior being related to an object, an activity, and/or an event;
wherein the at least one first raw datum and the at least one second raw datum originate from different distributed data sources controlled by different owners.

19. The method of claim 18, wherein the step of obtaining at least one first raw datum and at least one second raw datum is performed in real-time.
